(19) United States
(12) Patent Application Publication
(10) Pub. No.: US 2008/0051515 A1
(43) Pub. Date: Feb. 28, 2008

(54) Ultra high molecular weight polyethylene articles

(76) Inventor: Stanley P. Dudek, Galveston, TX (US)

Correspondence Address: FORREST L. COLLINS LAW OFFICES, LLC, P. O. BOX 41040, BRECKSVILLE, OH, 44141-0040, US

(21) Appl. No.: 11/507,926

(22) Filed: Aug. 22, 2006

(51) Int. Cl. C08F 8/00; C08L 23/04

(52) U.S. Cl. 525/191; 525/240

(57) ABSTRACT

The present invention describes an advantageous way of processing ultra high molecular weight polyethylene during an extrusion or injection molding process. The ultra high molecular weight polyethylene may be formed into pipes and other useful articles.

### BACKGROUND OF THE INVENTION

1. Field of the Invention

This invention relates to the manufacture of articles from ultra high molecular weight polyethylene especially pipe. A problem in the processing of ultra high molecular weight polyethylene from the powdered state is the speed of fusion of the ultra high molecular weight polyethylene. The present invention obtains an article such as pipe from a pellet rather than a powder.

2. Description of the Art Practices

Lee, et al. In U.S. Pat. No. 4,355,116 issued Oct. 19, 1982, is stated to disclose stable single film bipolar membranes of prolonged life and improved performance particularly for use in electrodialysis water splitting process, are prepared by introducing a more stable interface in the membrane structure. After the cationic exchange groups are preformed on an insoluble cross-linked aromatic polymeric matrix, the dissociable anionic exchange groups may be introduced more intimately chemically bonded in position by using multi-functional compounds containing mixed tertiary, secondary and primary amine groups, so that the resulting interface is comparatively more stable, and is less likely to be neutralized, therefore, attaining longer life-time and a higher level of performance.

U.S. Pat. No. 5,079,287 issued Jan. 7, 1992 to Takeshi, et al., describes an olefin resin composition for injection molding, which comprises (A) an olefin resin composition comprising ultra-high-molecular-weight polyethylene having an intrinsic viscosity of 10 to 40 dl/g as measured in decalin as the solvent at 135° C. and low-molecular-weight or high-molecular-weight polyethylene having an intrinsic viscosity lower than that of the ultra-high-molecular-weight polyethylene, in which the ultra-high-molecular-weight polyethylene is present in an amount of 15 to 40% by weight based on the sum of both of the polyethylenes and the two polyethylenes as a whole have an intrinsic viscosity [.eta.] c of 3.5 to 15 dl/g and a melt torque T lower than 4.5 kg.cm, and (B) 1 to 70% by weight, based on the olefin resin composition, of an additive selected from the group consisting of fine particulate inorganic fillers, fibrous fillers and liquid and solid lubricants.

U.S. Pat. No. 6,328,681 issued Dec. 11, 2001, to Stephens, discloses industrial roll of the present invention comprises a substantially cylindrical core, an adhesive layer overlying the core, and a cover overlying the adhesive layer. The cover comprises: a polymeric base layer overlying the adhesive layer; and a top stock layer overlying the base layer. The top stock layer comprises a mixture of an elastomeric material and ultra high molecular weight polyethylene (UHMWPE), with the mixture including 100 parts elastomeric material by weight and between about 25 and 50 parts UHMWPE by weight. With these components in the recited ratios, the roll can be formulated to a desired hardness within the desired 10 to 50 P&J hardness range while maintaining release properties suitable for papermaking in the papermaking environment

U.S. Pat. No. 6,521,709 issued Feb. 18, 2003, to Pifteri, et al., s discloses a polyolefin composition comprising from 10 to 95% by weight of a crystalline propylene polymer, A) having an MFR value equal to or lower than 60 g/10 min., and from 5 to 90% by weight of an ultra high molecular weight polyethylene, B) in form of particles having a mean particle size of from 300 to 10.mu.m.

In U.S. Pat. No. 6,780,361 issued Aug. 24, 2004, to Sridharan, et al., there is disclosed a method including forming a pseudo-gel of a semi-crystalline polymer material and a solvent. The pseudo-gel is shaped into a first form and stretched. A portion of the solvent is removed to create a second form. The second form is stretched into a microstructure including nodes interconnected by fibrils. A method including forming a first form of a pseudo-gel including an ultra-high molecular weight polyethylene material and a solvent; stretching the first form; removing the solvent to form a second form; stretching the second form into a microstructure including nodes interconnected by fibrils; and annealing the stretched second form. An apparatus including a body portion formed of a dimension suitable for a medical device application and including a polyolefin polymer including a node and a fibril microstructure. An apparatus including a body portion including an ultra-high molecular weight polyolefin material including a node and a fibril microstructure.

U.S. Pat. No. 6,790,923 issued Sep. 14, 2004, to Smith, et al., discloses melt-processible, thermoplastic polyethylene compositions of high resistance against wear are disclosed and methods for making and processing same. Additionally, products comprising these compositions are described.

In U.S. Pat. No. 6,855,785 issued Feb. 15, 2005, to Baumgart, et al., there is disclosed a heat-curable composition comprising (I) at least one constituent whose molecule comprises on average (A) at least one functional group containing at least one bond which may be activated by means of heat and/or actinic radiation, and/or (B) at least one reactive functional group which is able to undergo thermal crosslinking reactions with groups of its own kind and/or with complementary reactive functional groups, with the proviso that there are always groups (A) and (B) in the composition; said constituent excluding the polyurethane dispersion synthesized from aliphatic polyisocyanates, compounds containing isocyanate-reactive functional groups and containing bonds that may be activated with actinic radiation, low molecular mass aliphatic compounds containing isocyanate-reactive functional groups, compounds containing isocyanate-reactive functional groups and dispersing functional groups, neutralizing agents for the dispersing functional groups, blocking agents for isocyanate groups, and/or compounds containing blocked isocyanate groups, the blocked isocyanate groups being introduced into the polyurethane dispersion by the reaction of the blocking agents with isocyanato-containing polyurethane prepolymers; and (II) from 0.5 to 15% by weight, based on the solids of the heat-curable composition, of at least one C-C-cleaving initiator.

U.S. Pat. No. 6,855,787 issued Feb. 15, 2005, to Funaki, et al., discloses a multi-layer hose which is excellent in the interlayer adhesion strength and the fuel barrier property and which exhibits fuel resistance of the excellent interlayer adhesion strength over a long period of time. A component utilized by Funaki, et al., is UHMWPE.

In U.S. Pat. No. 6,989,198 issued Jan. 24, 2006, to Masuda, et al., there is described a multi-layer structure excellent in the alcohol gasoline permeation-preventing properties and, particularly, hydrocarbon component permeation-preventing properties, and also excellent in the interlayer adhesion, low-temperature impact resistance, heat resistance and chemical resistance. A component utilized by Masuda, et al., is UHMWPE.

In U.S. Pat. No. 7,019,042 issued Mar. 28, 2006, to Rockmart, et al., the coating, bonding or sealing of primed or unprimed plastics parts is disclosed, for example, of ABS, AMMA, ASA, CA, CAB, EP, UF, CF, MF, MPF, PF, PAN, PA, PE, HDPE, LDPE, LLDPE, UHMWPE, PC, PC/PBT, PC/PA, PET, PMMA, PP, PS, SB, PUR, PVC, RF, SAN, PBT, PPE, POM, PUR-RIM, SMC, BMC, PP-EPDM and UP (abbreviations to DIN 7728P1). Unfunctionalized and/or nonpolar substrate surfaces may be subjected to conventional pre-coating treatment, such as with a plasma or by a flaming, or may be given a water-based primer.

In U.S. Pat. No. 7,037,970 issued Mehta, et al., to May 2, 2006, there is disclosed ethylene polymer composites, concentrates and a process utilized for their preparation are provided. The composites of the invention have increased melt strength compared to the base resin and other improved physical characteristics. The composites contain an organically modified clay and may also contain a compatibilizng agent, depending on the base resin used.

Throughout the specification and claims, percentages and ratios are by weight, temperatures are in degrees Celsius, and pressures are in Kpa gauge unless otherwise indicated. To the extent that any of the references cited herein are applicable, they are hereby specifically incorporated by reference. Ranges and ratios given herein may be combined.

### SUMMARY OF THE INVENTION

The present invention describes a composition comprising a pellet of a thermoplastic rubber and an ultra high molecular weight polyethylene said composition having an MFR 250° C. value at 2.5 Kg from 0.1 to 6 as measured by ASTM D1238.

The present invention also describes a composition comprising a pellet of a thermoplastic rubber and an ultra high molecular weight polyethylene said composition having a tensile strength as measured by ASTM D-638 of less than 2850 psi.

The present invention further describes a composition comprising a pellet of a thermoplastic rubber and an ultra high molecular weight polyethylene said composition having a tensile modulus as measured by ASTM D-638 of less than 110,000 psi.

The present invention also describes a composition comprising a pellet of a thermoplastic rubber and an ultra high molecular weight polyethylene said composition having a flexural modulus as measured by ASTM D-790 of less than 130,000 psi.

The compositions of the present invention provide an easy to use pellet that provides an end use product such as pipe having improved abrasion resistance. That is, when the pipe is employed in an environment where abrasive materials are present the pipe may be used for a significant period of time before it must be replaced. Such an environment is, for example, a water intake pipe.

The compositions of the present invention behave as a thermoplastic thereby permitting melt processing to obtain an end use product rather than by compression processing. Historically, ultra high molecular weight polyethylene has been processed into various shapes, such as blocks, rods, and sheet, by compression, molding or ram extrusion. This type of processing was required because the ultra high molecular weight polyethylene alone does not have flow characteristics, such as melt index, which other polymers exhibit.

It has been suggested that materials such as oils, waxes and other lubricants can be compounded into ultra high molecular weight poly-ethylene to help it obtain flow characteristics. These other materials, however, lower the physical properties of the ultra high molecular weight polyethylene when these materials are used at a level that would allow a melt index to be measured. The foregoing issues have essentially precluded the use of ultra high molecular weight polyethylene that is processed into a pellet that is then useful for injection molding or extrusion.

To accomplish the desired flow characteristics for ultra high molecular weight polyethylene a processing aid is included to permit extrusion processing and to speed the fusion of the ultra high molecular weight polyethylene. The improved fusion characteristics permits the ultra high molecular weight polyethylene to be processed on standard plastic processing equipment such as single or twin screw extruders and injection molding machines. Molded parts produced from the modified ultra high molecular weight polyethylene pellets of the present invention exhibit excellent abrasion resistance, an important characteristic that ultra high molecular weight polyethylene is known to exhibit in compression molding.

An objective of this invention is to show that ultra high molecular weight polyethylene may be processed with desirable flow characteristics without the need for oils, waxes, or lubricants. Furthermore, such an ultra high molecular weight polyethylene pellets may be processed on standard plastic compounding equipment such as injection molding machines and extruders to produce various shaped articles such as pipe.

### DETAILED DESCRIPTION OF THE INVENTION

### The Thermoplastic Rubber Component

The thermoplastic rubber component is preferably a styrene block copolymer containing amounts of comonomers, in particular selected from ethylene and .alpha.-olefins C₄-C₁₂, such as but not limited to 1-butene, 1-pentene, 1-hexene, 4-methyl-1-pentene, 1-octene, 1-decene, and isoprene.

The M_{w}/Mₙ values for the thermoplastic rubber component preferably can range from 2 to 60. The value of flexural modulus of the thermoplastic rubber component as measured by ASTM D-790 of less than 130,000 psi measured according to ASTM D-790. Preferably, the flexural modulus is less than 120,000 psi.

A particular example of the thermoplastic rubber component is one having a broad molecular weight distribution in terms of M_{w}/Mₙ namely having M_{w}/Mₙ values equal to or higher than 5, in particular from 5 to 60, more preferably from 3 to 10.

In particular, the flexural modulus, the tensile strength at yield and the spiral flow (which is a test method commonly used to evaluate the flowability in the molten state and, consequently, the melt-processability) of the compositions of the invention are improved when the thermoplastic rubber component with broad molecular weight distribution is used. The above Styrene block copolymers, constituting the thermoplastic rubber component, are well known in the art and commercially available.

### The Ultra High Molecular Weight Polyethylene Component

The ultra high molecular weight polyethylene component is an ethylene homopolymer or a copolymer. The ultra high molecular weight polyethylene conveniently has a molecular weight between 1,000,000 and 8,000,000 preferably having a molecular weight between 2,000,000 and 7,500,000.

### Component Usage and Processing

The components of the present invention are mixed together thoroughly and processed through an extruder. Typically, the extruder will achieve a temperature of 140° C. to 260° C., preferably 180° C. to 240° C.

Typically, the thermoplastic rubber is present in a weight ratio to the ultra high molecular weight polyethylene at about 1:50 to about 1:4. Preferably, the thermoplastic rubber is present in a weight ratio to the ultra high molecular weight polyethylene at about 1:40 to about 1:5. In use an ultra high molecular weight polyethylene powder is blended with the thermoplastic rubber and extruded into pellets. The pellets are generally cylindrical in shape with a diameter of about 3/32 inch to about 5/32 inch with a length of 5/32 inch to 7/32 inch. The pellet size is ideal for the processing as later described.

### Additional Components

Typically, many additional components may be utilized in the processing of the ultra high molecular weight polyethylene. The composition of the present invention may also include other additives to impart specific attributes to the composition. Non-limiting examples of such additives include antioxidants, lubricants, light stabilizers, antiblocking agents, heat stabilizers, biocides, compatibilizers, flame retardants, plasticizers, tackifiers, colorants and pigments.

Generally, any of the normally used components in the ultra high molecular weight polyethylene processing which do not materially interfere with the functioning of the system and the desired properties of the finished product may be employed. For instance, normally used components may be utilized herein at from 0.1 to 40 weight parts per 100 parts of the ultra high molecular weight polyethylene. Fillers and pigments may also be utilized herein typically at from 0.1 to 30 weight parts per 100 parts of the ultra high molecular weight polyethylene.

### Composition Properties

The extruded composition has an MFR 250° C. value at 2.5 Kg from 0.1 to 6 as measured by ASTM D1238. Preferably, the extruded composition has an MFR 250° C. value at 2.5 Kg from 0.2 to 5.5 as measured by ASTM D1238.

The extruded composition has a tensile strength as measured by ASTM D-638 of less than 2850 psi. Preferably, the extruded composition has a tensile strength as measured by ASTM D-638 of about 2600 psi to about 2825 psi.

The extruded composition has a tensile modulus as measured by ASTM D-638 of less than 130,000 psi. Preferably, the extruded composition has a tensile modulus as measured by ASTM D-638 of less than 110,000 psi.

From the above description of the invention, those skilled in the art will perceive improvements, changes and modifications. Such improvements, changes and modifications within the skill of the art are intended to be covered by the appended claims.

Certain portions of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

What is claimed is:

1. A composition comprising a pellet of a thermoplastic rubber and an ultra high molecular weight polyethylene said composition having an MFR 250° C. value at 2.5 Kg from 0.1 to 6 as measured by ASTM D1238.

2. The composition according to claim 1 wherein said ultra high molecular weight polyethylene has a molecular weight between 1,000,000 and 8,000,000.

3. The composition according to claim 1 wherein said thermoplastic rubber is a styrene block copolymer.

4. The composition according to claim 1 wherein said ultra high molecular weight polyethylene has a molecular weight between 2,000,000 and 7,500,000.

5. The composition according to claim 1 wherein said thermoplastic rubber is present in a weight ratio to said ultra high molecular weight polyethylene at about 1:50 to about 1:4.

6. The composition according to claim 1 wherein said composition has an MFR 250° C. value at 2.5 Kg from 0.2 to 5.5 as measured by ASTM D1238.

7. The composition according to claim 1 wherein said thermoplastic rubber is present in a weight ratio to said ultra high molecular weight polyethylene at about 1:40 to about 1:5.

8. A composition comprising a pellet of a thermoplastic rubber and an ultra high molecular weight polyethylene said composition having a tensile strength as measured by ASTM D-638 of less than 2850 psi.

9. The composition according to claim 8 wherein said ultra high molecular weight polyethylene has a molecular weight between 1,000,000 and 8,000,000.

10. The composition according to claim 8 wherein said thermoplastic rubber is a styrene block copolymer.

11. The composition according to claim 8 wherein said ultra high molecular weight polyethylene has a molecular weight between 2,000,000 and 7,500,000.

12. The composition according to claim 8 wherein said thermoplastic rubber is present in a weight ratio to said ultra high molecular weight polyethylene at about 1:50 to about 1:4.

13. The composition according to claim 8 wherein said composition has an MFR 250° C. value at 2.5 Kg from 0.2 to 5.5 as measured by ASTM D1238.

14. The composition according to claim 8 wherein said composition has a tensile strength as measured by ASTM D-638 of about 2600 psi to about 2825 psi.

15. The composition according to claim 8 wherein said thermoplastic rubber is present in a weight ratio to said ultra high molecular weight polyethylene at about 1:40 to about 1:5.

16. A composition comprising a pellet of a thermoplastic rubber and an ultra high molecular weight polyethylene said composition having a tensile modulus as measured by ASTM D-638 of less than 130,000 psi.

17. The composition according to claim 16 wherein said ultra high molecular weight polyethylene has a molecular weight between 1,000,000 and 8,000,000.

18. The composition according to claim 16 wherein said thermoplastic rubber is a styrene block copolymer.

16. The composition according to claim 16 wherein said ultra high molecular weight polyethylene has a molecular weight between 2,000,000 and 7,500,000.

20. The composition according to claim 16 wherein said composition has a tensile modulus as measured by ASTM D-638 of less than 110,000 psi.

21. The composition according to claim 16 wherein said thermoplastic rubber is present in a weight ratio to said ultra high molecular weight polyethylene at about 1:50 to about 1:4.

22. The composition according to claim 16 wherein said composition has an MFR 250° C. value at 2.5 Kg from 0.2 to 5.5 as measured by ASTM D1238.

23. The composition according to claim 16 wherein said composition has a tensile modulus as measured by ASTM D-638 of about 2600 psi to about 2825 psi.

24. The composition according to claim 16 wherein said thermoplastic rubber is present in a weight ratio to said ultra high molecular weight polyethylene at about 1:40 to about 1:5.

25. A composition comprising a pellet of a thermoplastic rubber and an ultra high molecular weight polyethylene said composition having a flexural modulus as measured by ASTM D-790 of less than 130,000 psi.

26. The composition according to claim 25 wherein said ultra high molecular weight polyethylene has a molecular weight between 1,000,000 and 8,000,000.

27. The composition according to claim 25 wherein said thermoplastic rubber is a styrene block copolymer.

28. The composition according to claim 25 wherein said ultra high molecular weight polyethylene has a molecular weight between 2,000,000 and 7,500,000.

29. The composition according to claim 25 wherein said composition has a flexural modulus as measured by ASTM D-790 of less than 120,000 psi.

30. The composition according to claim 25 wherein said thermoplastic rubber is present in a weight ratio to said ultra high molecular weight polyethylene at about 1:50 to about 1:4.

31. The composition according to claim 25 wherein said composition has an MFR 250° C. value at 2.5 Kg from 0.2 to 5.5 as measured by ASTM D1238.

33. The composition according to claim 25 wherein said composition has a tensile modulus as measured by ASTM D-638 of about 2600 psi to about 2825 psi.

34. The composition according to claim 25 wherein said thermoplastic rubber is present in a weight ratio to said ultra high molecular weight polyethylene at about 1:40 to about 1:5.

35. The composition according to claim 25 wherein said composition has a tensile modulus as measured by ASTM D-638 of less than 110,000 psi.
